(19) United States
(12) Patent Application Publication
(10) Pub. No.: US 2017/0353206 A1
(43) Pub. Date: Dec. 7, 2017

(54) DETACHABLE TABLET COMPUTER PROTECTIVE CASE

(71) Applicant: Boliang Lv, Guangzhou (CN)

(72) Inventor: Boliang Lv, Guangzhou (CN)

(21) Appl. No.: 15/176,177

(22) Filed: Jun. 8, 2016

(30) Foreign Application Priority Data
Jun. 6, 2016 (CN) 201620535217.7

(51) Int. Cl. H04B 1/3888

(52) U.S. Cl. CPC H04B 1/3888

(57) ABSTRACT

The invention relates to a detachable tablet computer protective case, wherein it consists of protective case and leather cover, and protective case connection area is equipped on one side of said protective case, wherein slot is set on said protective case connection area; wherein leather cover connection area is equipped on one side of said leather cover, wherein magnet is fixed on said leather cover connection area; wherein camera lens hole is equipped on the top of protective case; wherein logo hole is set on the middle position of protective case. The invention has a easy scientific structure; and can protect tablet computer from scratches and break; and can be portable tablet computer protective case through disassembly.

### FIELD OF THE INVENTION

The invention relates to a tablet computer protective case, especially a detachable tablet computer protective case.

### BACKGROUND OF THE INVENTION

With the increasing development of tablet computers , protective leather case and cover spring up as well. However, protective leather case and cover in current market are generally independent of each other and cannot be used with combined function.

### SUMMARY OF THE INVENTION

To solve existing problems, the invention discloses a detachable tablet computer protective case, wherein it consists of protective case 1 and leather cover 2, and protective case connection area 3 is equipped on one side of said protective case 1, wherein slot 4 is set on said protective case connection area 3; wherein leather cover connection area 5 is equipped on one side of said leather cover 2, wherein magnet 6 is fixed on said leather cover connection area 5; wherein camera lens hole 7 is equipped on the top of protective case 1; wherein logo hole 8 is set on the middle position of protective case 1.

Preferably, said magnet 6 is bar-shaped with smooth edge.

Preferably, said protective case 1 is made of metal or hard plastic.

Preferably, said protective case 1 is molding by one compression.

Advantages: The invention has a easy scientific structure; and can protect tablet computer from scratches and break; and can be portable tablet computer protective case through disassembly.

### BRIEF DESCRIPTION OF THE DRAWINGS

FIG. 1 is structure diagram of a detachable tablet computer protective case according to an embodiment of the invention.

FIG. 2 is structure diagram of leather cover according to an embodiment of the invention.

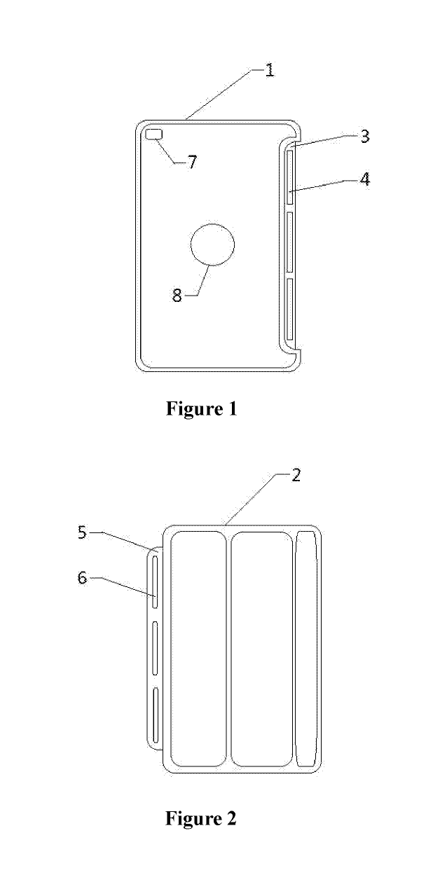

Wherein protective case 1, leather cover 2, protective case connection area 3, slot 4, leather cover connection area 5, magnet 6, camera lens hole 7, logo hole 8.

### DETAILED DESCRIPTION

In the following detailed description, reference is made to the accompanying drawings that form a part hereof, and in which it is shown by way of illustration specific implementations that may be practiced. These implementations are described in sufficient detail to enable those skilled in the art to practice the implementations, and it is to be understood that other implementations may be utilized and that logical, mechanical, electrical and other changes may be made without departing from the scope of the implementation. The following detailed description is, therefore, not to be taken in a limiting sense.

This description of the exemplary embodiments is intended to be read in connection with the accompanying drawings, which are to be considered part of the entire written description. In the description, relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

As is shown is the drawings, wherein it consists of protective case 1 and leather cover 2, and protective case connection area 3 is equipped on one side of said protective case 1, wherein slot 4 is set on said protective case connection area 3; wherein leather cover connection area 5 is equipped on one side of said leather cover 2, wherein magnet 6 is fixed on said leather cover connection area 5; wherein camera lens hole 7 is equipped on the top of protective case 1; wherein logo hole 8 is set on the middle position of protective case 1.

The said magnet 6 is bar-shaped with smooth edge, protective case 1 is made of metal or hard plastic, and protective case 1 is molding by one compression.

When the invention is used, said protective case 1 is equipped on the back of tablet computer, wherein said leather cover 2 is set on the front of tablet computer; wherein the connection of protective case 1 and leather cover 2 is realized through mutual attraction between slot 4 on protective case connection area 3 and magnet 6 on leather cover connection area 5; Disassembly can be achieved by gently pulling open.

The invention can be applied to the following products: 12.9 inches iPad Pro and 9.7 inches iPad Pro respectively published in November and March, 2016 by Apple Inc. Both new tablet computers are equipped with 3 metal contact points on the middle of left border, which is used to connect protective keyboard published by Apple Inc. However, integrated protective case on the market lead to that iPad Pro cannot connect with protective keyboard because the protective case covers 3 metal contact points on the middle of left border. When the ordinary case is in use, users must disassemble the case to realize the connection. When the detachable protective case is in use, users only need to detach the leather cover, which then become the protective case for iPad and can easily connect with protective keyboard.

Microsoft Inc launch a series of tablet computer like Surface, Surface Pro, which is equipped with independent professional keyboard cover so that tablet computer can be used alone or used with keyboard. integrated protective case on the market lead to that Surface and Surface Pro cannot connect with protective keyboard. When the detachable protective case is in use, users only need to detach the leather cover, which then become the protective case for iPad and can easily connect with protective keyboard.

The above embodiments only describe one or several embodiments of the invention, its description is more concreted and detailed but cannot hence be understood to limit the scope of the patent of the invention. It should be pointed out that those skilled in the art can also make a plurality of modifications and improvements without departing from the concept of the invention, which all belong to the protection scope of the invention. Therefore, for the protection scope of the patent of the invention, the appended claims should prevail.

1. A detachable tablet computer protective case, wherein it consists of protective case and leather cover, and protective case connection area is equipped on one side of said protective case, wherein slot is set on said protective case connection area; wherein leather cover connection area is equipped on one side of said leather cover, wherein magnet is fixed on said leather cover connection area; wherein camera lens hole is equipped on the top of protective case; wherein logo hole is set on the middle position of protective case.

2. A detachable tablet computer protective case according to claim 1, wherein said magnet is bar-shaped with smooth edge.

3. A detachable tablet computer protective case according to claim 1, wherein said protective case is made of metal or hard plastic.

4. A detachable tablet computer protective case according to claim 1, wherein said protective case is molding by one compression.
